(19) United States
(12) Patent Application Publication
(10) Pub. No.: US 2026/0278248 A1
(43) Pub. Date: Sep. 17, 2026

(54) EFFICIENT TEXT REPLACEMENT WITH LARGE LANGUAGE MODELS

(71) Applicant: SAP SE, Walldorf (DE)

(72) Inventor: David Kunz, Wilhelmsfeld (DE)

(21) Appl. No.: 19/081,419

(22) Filed: Mar. 17, 2025

(51) Int. Cl. G06F 40/166; G06F 40/40

(52) U.S. Cl. CPC G06F 40/166; G06F 40/40

(57) ABSTRACT

In an example embodiment, a framework is provided to interact with a large language model (LLM) in a way that allows for more efficient text replacement by the LLM. More specifically, a host program is provided that generates a specialized prompt to the LLM to request that the LLM correct or otherwise modify a portion of the document while only outputting the specific changes to be made as opposed to unchanged portions. A change implementation component on the host program will then implement the specific changes from the LLM on the original document to create a modified version of the document that incorporates the specific changes from the LLM.

### TECHNICAL FIELD

This document generally relates to computer systems. More specifically, this document relates to the use of large language models.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for automatically making changes to a portion of a document, in accordance with an example embodiment.

FIG. 2 is a flow diagram illustrating a method for efficient text replacement using an LLM for processing and modifying text within a document, in accordance with an example embodiment.

FIG. 3 is a block diagram illustrating an architecture of software, which can be installed on any one or more of the devices described above.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In the realm of text processing and modification, large language models (LLMs) are frequently employed to enhance or correct text, such as modifying computer code or rectifying grammatical or stylistic errors in documents. Traditional methods often involve generating an entirely new document, which can be inefficient and costly, particularly when only minor modifications are required. More specifically, a user or system prompts the LLM to correct errors in a document, and the LLM returns a new version of the document. Even when the user or system is only specifying corrections be made to a portion of a document, a corrected version of the entire portion of the document is returned as output by the LLM.

The inefficiency thus arises because the output includes unchanged portions of the document, leading to unnecessary computational expense and resource usage.

One solution would be to have unique markers to break up the locations of the original document and allow the LLM to make reference to those unique markers when indicating corrections. For example, line numbers may exist, or be placed in, the original document. The LLM could then be prompted to return changes to the document in a form that specifies the line numbers on which the corrections should take place. This, however, does not work in real-world scenarios since LLMs have difficulty interpreting numbers intermixed with alphabetic characters as anything other than part of the language of the document itself as opposed to what they are intended to be in this scenario, namely merely markers. Additionally, LLMs cannot perform calculations in a reliable away, or at least not reliable enough for line number-based diff calculations.

In an example embodiment, a framework is provided to interact with an LLM in a way that allows for more efficient text replacement by the LLM. More specifically, a host program is provided that generates a specialized prompt to the LLM to request that the LLM correct or otherwise modify a portion of the document while only outputting the specific changes to be made as opposed to unchanged portions. A change implementation component on the host program will then implement the specific changes from the LLM on the original document to create a modified version of the document that incorporates the specific changes from the LLM.

This allows for precise modifications to be made to portions of documents without the need for the LLM to reproduce unchanged portions of the document. This technique significantly reduces computational costs and increases processing speed, as it avoids the inefficiencies associated with handling large volumes of unchanged text. Additionally, the method circumvents the limitations of previous techniques, such as the reliance on line numbers, by leveraging the LLM's ability to identify distinct text strings, which is a more intuitive and less error-prone process.

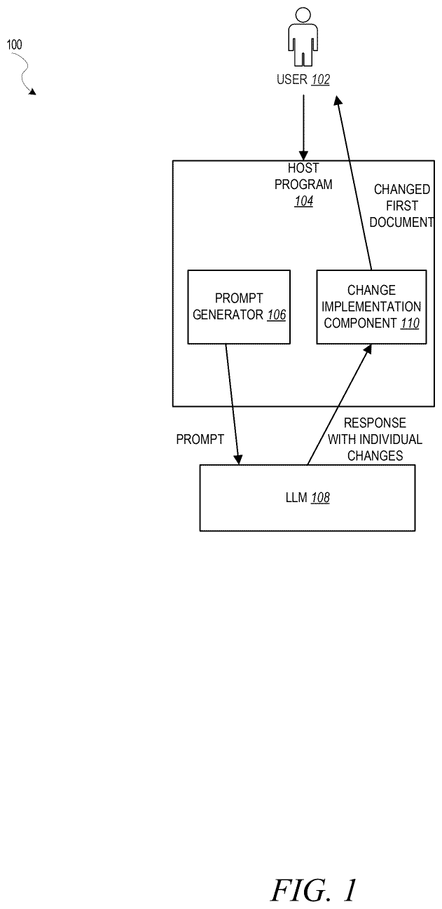

FIG. 1 is a block diagram illustrating a system 100 for automatically making changes to a portion of a document, in accordance with an example embodiment. Here, a user 102 causes a host program 104 to begin the process of making the changes to the portion of the document. This may be performed in a number of different ways. In some example embodiments, the user 102 may explicitly instruct the host program to change a portion of a document, such as by sending an explicit request to the host program (e.g., typing in a text box, “Please make the following text into a formal letter,” followed by the portion of the document to be formalized, or performing the same function using non-text commands, such as by selecting a portion of a document using a cursor and then pressing a specific button for formalizing text). In other example embodiments, the user's intent to change the portion of the document may be partially or completely inferred, such as by detecting that the user 102 is repeatedly modifying the portion of the document on their own without success.

Additionally, the portion of the document that is to be changed may or may not be directly communicated from the user 102 to the host program 104. For example, in some example embodiments, the user may explicitly write or cut and paste the text to be changed to the host program 104. In other example embodiments, the user may simply provide an indication of what the portion of the document is (e.g., “please modify the introduction section of the document entitled ‘Presentation.doc’”).

In another example embodiment, the user does not provide a specific portion of the document but rather provides the entire document along with some instruction, relying on the system 100 to determine which portion needs to be changed.

Regardless of how it is communicated, at some point the host program 104 determines that a specific portion of a document (which may or may not be the entire document) should be changed and has a general understanding of the purpose of the changes (e.g., correct grammar, formalize, fix buggy code, etc.).

The host program 104 then utilizes a prompt generator 106 to generate a prompt to an LLM 108 to make changes in line with the general understanding of the purposes of the changes. While this prompt can take many forms, at the very least it will include an indication of the portion of the document to be changed and the purpose of the change or changes.

As will be described in more detail below, the prompt may also include instructions to generate the changes and output just portions having a change and not portions not having a change, as well as to generate all the changes in a single response (as opposed to one-at-a-time).

The prompt will then be sent by the host program 104 to the LLM 108, which generates the changes to the position of the document in accordance with the instructions in the prompt. This output is then returned to the host program 104, which then utilizes a change implementation component 110 to implement the changes.

The prompt generator 106 may design the prompt based on knowledge of the change implementation component 110 and how the change implementation component 110 will implement the suggested changes from the LLM 108. For example, the change implementation component 110 may be designed to handle changes specified in a particular format. This format may be known to the prompt generator 106, which may generate the prompt in a manner that causes the LLM 108 to generate the changes in that particular format.

The format itself could have many different implementations. In one example implementation, the format is one in which each change is specified using a starting string and an ending string, such as the following specified as a JavaScript Object Notation (JSON) object:

```
    “‘json
    { uniqueStartingString: ″<unique starting string to identify the beginning of
    the text portion>″,
uniqueEndingString: ″<unique ending string to identify the beginning of the text
portion>″,
  modifiedText: ″<the newly modified text, replacing the uniqueStartingString
and any additional text after the uniqueStartingString up to the
uniqueEndingString>″
    }
“‘
```

In the above example, the LLM may be further instructed to select the uniqueStartingString such that it uniquely identifies locations where the change should occur and does not also identify locations where the change should not occur. Thus, for example, assume a portion of a document to be changed reads as follows:
I do not like dogs in my house
I do not like cats in my house
I do not like canines in my house

Assume that the changes involve the realization that the user actually likes dogs, rather than dislikes dogs, and hence proposes to change the first and third line accordingly. The goal would be to change the “I do not like” language to “I like” in the first and third lines, but not the second line.

Choosing a starting string, such as “I do” or even “I do not like,” is not unique enough for the changes proposed, because both of those starting strings are found in the second line. As such, the LLM is essentially being instructed to expand the starting string until it is unique. In this case, this would mean that there is no common way to specify changes to both the first and third lines, and thus there would need to be an output of:

```
  “‘json
    [{ uniqueStartingString: “I do not like dogs”,
    uniqueEndingString: “in my house”,
    modifiedTExt “I like dogs”
    },
    { uniqueStartingString: “I do not like canines”,
    uniqueEndingString: “in my house”,
    modifiedText “I like canines”
    }]
“‘
```

The expansion itself can take many forms. In some example embodiments even adding just a few characters to a non-unique string can make the string unique. In other example embodiments, the string itself may be unique even without any expansion, thus eliminating the need for the LLM to perform any specific expansion on the string.

Assume on the other hand, the document was originally worded like this:
I do not always like dogs in my house
I do not like cats in my house
I do not always like canines in my house

In this case there would be a way to find a unique starting string that encompasses both changes, if the unique starting string was “do not always” or “I do not always,” which are both present in the first and third lines but not the second. In this case, the output could be:

“‘json
{ uniqueStartingString: “I do not always”,
uniqueEndingString: “like”,
modifiedText “I”
}

An alternative format may be provided for the changes in the output where the changes are specified as a series of search string substitutions, again formatted based on the change implementation component 110. For example, the change implementation component 110 may perform changes using a text editor such as VIM. In Vim, there are substitution commands that can make use of regular expressions to replace text. Thus, the prompt generator 106 may generate the prompt to include the following:

Given a document and a request for changes, produce a list of substitutions in the syntax

“‘substitutions
[s/<searchString>/<replacement>, ...]
“‘

All substitutions act on the _original_ document (it's not that they are applied one by another).

Later, all differences will be merged together by me.

Make sure to create the substitutions to _only_ replace what you actually want to replace.

If it becomes too complicated, you can also just output the final document instead.
″′
this is an example
″′
[s/is/1s, s/is/i5]

This may result in the LLM 108 producing an array of search string/replacement pairs, which can be implemented by the change implementation component 110 as-is, since the pairs are already formatted for how the text editor will process those changes.

Thus, there is synergy between the prompt generator 106 and the change implementation component 110 to enable the aforementioned efficiency.

It should be noted that there is no requirement that the change implementation component 110 perform the implementations of the change without user approval or additional user input. In some example embodiments, the change implementation component 110 provides the user 102 with the ability to accept or reject each of the changes, and only implements those changes that the user 102 has accepted. In additional example embodiments, a mechanism is provided to link the rejected changes back to the prompt generator 106 to generate a prompt to the LLM 108 to reprocess or otherwise regenerate just the rejected changes, possibly including the rejection of the change(s) as context for the subsequent prompt to the LLM 108. Thus if, for example, the LLM 108 initially returns suggestions to make ten different changes to a particular portion of computer code, and the user accepts nine of those changes but rejects one of those changes, the rejected change may be communicated to the prompt generator 106, which generates a new prompt to the LLM 108 requesting that the rejected change be re-evaluated and itself changed to a different suggested change. This different suggested change may then be output by the LLM 108 to the change implementation component 110, which then, having waited to implement the first nine changes, processes all ten changes (the original first nine and now the different suggested tenth change) all at once.

It may be desirable for the change implementation component 110 to process all changes in one batch rather than handle them individually. This helps prevent issues where there are potentially conflicting changes.

For example, assume the original text read as follows:
″′
This is great
This is not so bad
″,

Assume then that the LLM suggests sorting but not completely reversing both of these statements, namely:
[s/great/bad, s/bad/great]

The goal would be to change the text to read as follows:
′″
This is bad
This is not so great
″,

Nevertheless, processing these two replacements individually results in a first pass where the text reads as:
′″
This is bad
This is not so bad
″,

Then when the second change is processed, the LLM overwrites the rewritten text from the first change, resulting in the following (incorrect) text:
′″
This is great
This is not so great
″,

By having the change implementation component 110 implement the changes as a batch rather than completely independently, such errors can be avoided. Specifically, the change implementation component 110 could be provided with a specialized function that is able to recognize when such conflicting, or at least potentially conflicting, replacements are suggested and utilize a technique to create interim versions of the portion of the document to be merged. Thus, rather than, for example, the first change being applied to the original text and then the second change being applied to the changed text after the first change has been applied, the first change is applied to the original text, creating a first changed version, and then the second change is applied to the original text, creating a second changed version. The first changed version and the second changed version could then be merged to arrive at a final version. This implementation also has the additional benefit of allowing for parallel processing of the substitutions, since each substitution is being applied to the original text and could be performed simultaneously (and even out of order). The fact that the changes will each be implemented on the original version of the portion of the document could also be communicated to the LLM 108 by the prompt generator 106, to allow the LLM 108 to output the appropriate recommended substitutions.

As to the LLM 108, LLMs that are used to generate information are generally referred to as Generative Artificial Intelligence (GAI) models. A GAI model may be implemented as a generative pretrained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model, known as a transformer, to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game, according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and the discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational Auto-Encoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

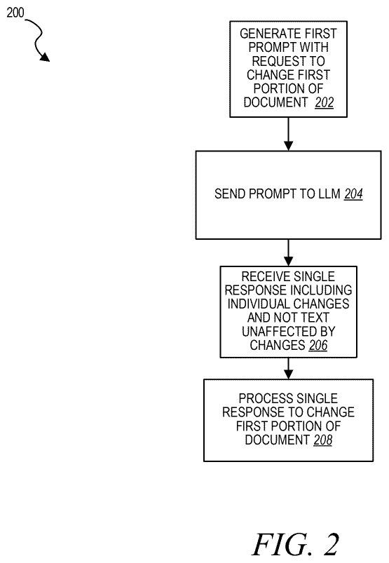

FIG. 2 is a flow diagram illustrating a method 200 for efficient text replacement using an LLM for processing and modifying text within a document, in accordance with an example embodiment. Although the example method 200 depicted in FIG. 2 shows a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method 200 may perform functions at substantially the same time or in a specific sequence.

At operation 202, the method 200 begins with generating a first prompt that includes a request to modify a first portion of a document. This operation is performed by a prompt generator component within a host program. The prompt includes instructions to identify changes to the first portion of the document as one or more individual changes and to output these changes in a specified format. The data used in this operation includes the original document and the specific instructions for modification.

At operation 204, the first prompt is sent to a large language model (LLM) for processing. The host program interfaces with the LLM, transmitting the prompt over a communication channel. The LLM receives the prompt and begins processing the request to identify the requested changes.

At operation 206, the method 200 involves receiving a single response from the LLM. This response comprises all of the one or more individual changes to the first portion of the document. The response does not contain text of the first portion of the document that is not affected by the changes. The host program receives this response and prepares it for further processing.

At operation 208, the single response is processed using a software component designed to handle instructions in the specified format. This component, known as the change implementation component, modifies the first portion of the document based on the individual changes identified by the LLM. The data used in this operation includes the original document and the response from the LLM.

The sequence of operations from operation 202 to operation 208 may involve decision-making processes that determine the flow of the method 200. For instance, if the LLM's response includes changes that are not in the expected format, the host program may generate a new prompt to request clarification or reprocessing of the changes. Additionally, the method 200 may include operations where the user is prompted to review and approve the changes before they are implemented.

In some examples, the operations described in operations 202 to 208 may be performed in parallel or in a different sequence. For instance, the prompt generation and LLM processing may occur simultaneously if the system is designed to handle multiple requests concurrently. Alternatively, the change implementation component may process changes in batches to optimize performance and reduce processing time.

Overall, the method 200 described in FIG. 2 provides a structured approach to efficiently modifying text within a document using LLMs. The use of a prompt generator, LLM, and change implementation component allows for precise and efficient text replacement, reducing computational costs and improving processing speed.

In one embodiment, the system utilizes a distributed architecture where the at least one hardware processor is part of a cloud-based infrastructure, allowing for scalable processing of large documents by distributing tasks across multiple servers. This configuration can enhance the system's ability to handle high volumes of text replacement requests simultaneously. In another embodiment, the system is implemented on a local server or personal computer, providing a more secure environment for processing sensitive documents without the need for internet connectivity. The computer-readable medium in this embodiment could be a solid-state drive (SSD) or a hard disk drive (HDD), depending on the storage requirements and cost considerations. Additionally, the software component designed to process instructions in the first format could be a standalone application or integrated into existing word processing software, offering flexibility in how users interact with the system. The system may also include a user interface that allows for real-time visualization of changes, enabling users to review and approve modifications before they are applied to the document. This interface could be a web-based application accessible through a browser or a desktop application, depending on user preferences and deployment scenarios. Furthermore, the system could support various document formats, such as plain text, rich text, or specific programming languages, to accommodate different user needs and applications.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: generating a first prompt comprising a request to modify a first portion of a document, the request comprising instructions to identify changes to the first portion of the document as one or more individual changes to the first portion and to output the changes in a first format; sending the first prompt to a Large Language Model (LLM) for processing; receiving, from the LLM, a single response comprising all of the one or more individual changes to the first portion, the single response not containing text of the first portion of the document not affected by the one or more individual changes; and processing the single response using a software component designed to process instructions in the first format, the processing comprising modifying the first portion of the document based on the one or more individual changes.

In Example 2, the subject matter of Example 1 includes, wherein the first portion of the document comprises computer code.

In Example 3, the subject matter of Examples 1-2 includes, wherein the single response comprises an array of one or more text replacement instructions.

In Example 4, the subject matter of Example 3 includes, wherein the array comprises, for each of the one or more text replacement instructions, a command to perform a replacement of one string for another string, written in a computer language executable by the software component.

In Example 5, the subject matter of Examples 3-4 includes, wherein each of the one or more text replacement instructions identifies a unique starting string, a unique ending string, and replacement text.

In Example 6, the subject matter of Examples 3-5 includes, wherein the one or more text replacement instructions indicate expansion of replacement text until the replacement text is unique.

In Example 7, the subject matter of Examples 3-6 includes, wherein each of the one or more text replacement instructions identifies the single response comprising a JavaScript Object Notation (JSON) object.

In Example 8, the subject matter of Examples 1-7 includes, wherein the operations further comprise: rendering, in a graphical user interface, an indication of all of the one or more individual changes; receiving input from a user, via the graphical user interface, indicating that a particular individual change of the one or more individual changes should not be implemented; generating a second prompt comprising a second request to modify the first portion of the document, the second request comprising instructions to alter the particular individual change to a different individual change; sending the second prompt to the LLM; receiving, from the LLM, a second response comprising the different individual change; and replacing the particular individual change with the different individual change in the one or more individual changes.

Example 9 is a method comprising: generating a first prompt comprising a request to modify a first portion of a document, the request comprising instructions to identify changes to the first portion of the document as one or more individual changes to the first portion and to output the changes in a first format; sending the first prompt to a Large Language Model (LLM) for processing; receiving, from the LLM, a single response comprising all of the one or more individual changes to the first portion, the single response not containing text of the first portion of the document not affected by the one or more individual changes; and processing the single response using a software component designed to process instructions in the first format, the processing comprising modifying the first portion of the document based on the one or more individual changes.

In Example 10, the subject matter of Example 9 includes, wherein the first portion of the document comprises computer code.

In Example 11, the subject matter of Examples 9-10 includes, wherein the single response comprises an array of one or more text replacement instructions.

In Example 12, the subject matter of Example 11 includes, wherein the array comprises, for each of the one or more text replacement instructions, a command to perform a replacement of one string for another string, written in a computer language executable by the software component.

In Example 13, the subject matter of Examples 11-12 includes, wherein each of the one or more text replacement instructions identifies a unique starting string, a unique ending string, and replacement text.

In Example 14, the subject matter of Examples 11-13 includes, wherein each of the one or more text replacement instructions identifies the single response comprising a JavaScript Object Notation (JSON) object.

In Example 15, the subject matter of Examples 9-14 includes, rendering, in a graphical user interface, an indication of all of the one or more individual changes; receiving input from a user, via the graphical user interface, indicating that a particular individual change of the one or more individual changes should not be implemented; generating a second prompt comprising a second request to modify the first portion of the document, the second request comprising instructions to alter the particular individual change to a different individual change; sending the second prompt to the LLM; receiving, from the LLM, a second response comprising the different individual change; and replacing the particular individual change with the different individual change in the one or more individual changes.

Example 16 is a non-transitory machine-readable medium storing instructions which, when executed by one or more processors, cause the one or more processors to perform operations comprising: generating a first prompt comprising a request to modify a first portion of a document, the request comprising instructions to identify changes to the first portion of the document as one or more individual changes to the first portion and to output the changes in a first format; sending the first prompt to a Large Language Model (LLM) for processing; receiving, from the LLM, a single response comprising all of the one or more individual changes to the first portion, the single response not containing text of the first portion of the document not affected by the one or more individual changes; and processing the single response using a software component designed to process instructions in the first format, the processing comprising modifying the first portion of the document based on the one or more individual changes.

In Example 17, the subject matter of Example 16 includes, wherein the first portion of the document comprises computer code.

In Example 18, the subject matter of Examples 16-17 includes, wherein the single response comprises an array of one or more text replacement instructions.

In Example 19, the subject matter of Example 18 includes, wherein the array comprises, for each of the one or more text replacement instructions, a command to perform a replacement of one string for another string, written in a computer language executable by the software component.

In Example 20, the subject matter of Examples 18-19 includes, wherein each of the one or more text replacement instructions identifies a unique starting string, a unique ending string, and replacement text.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

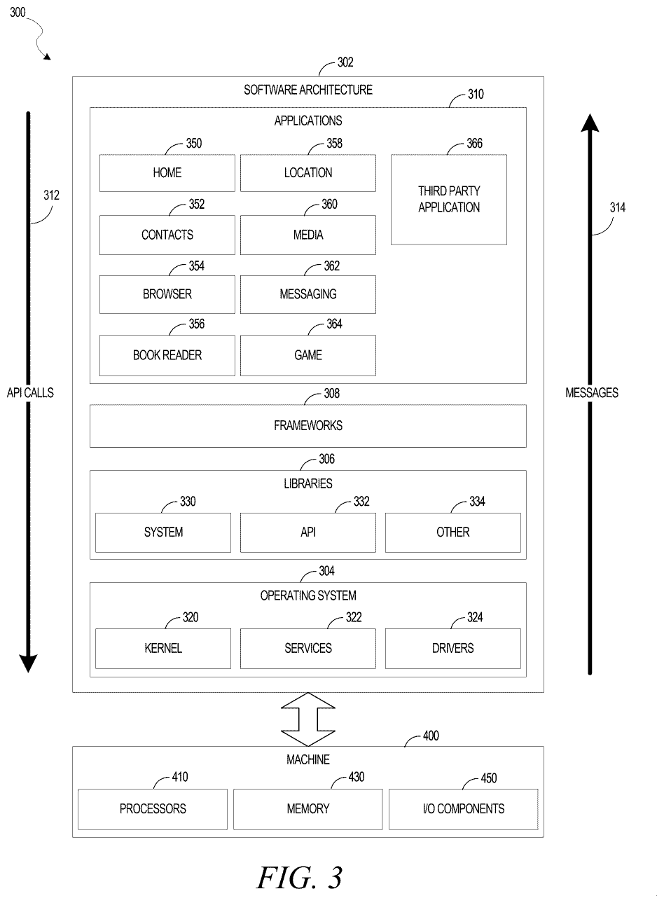

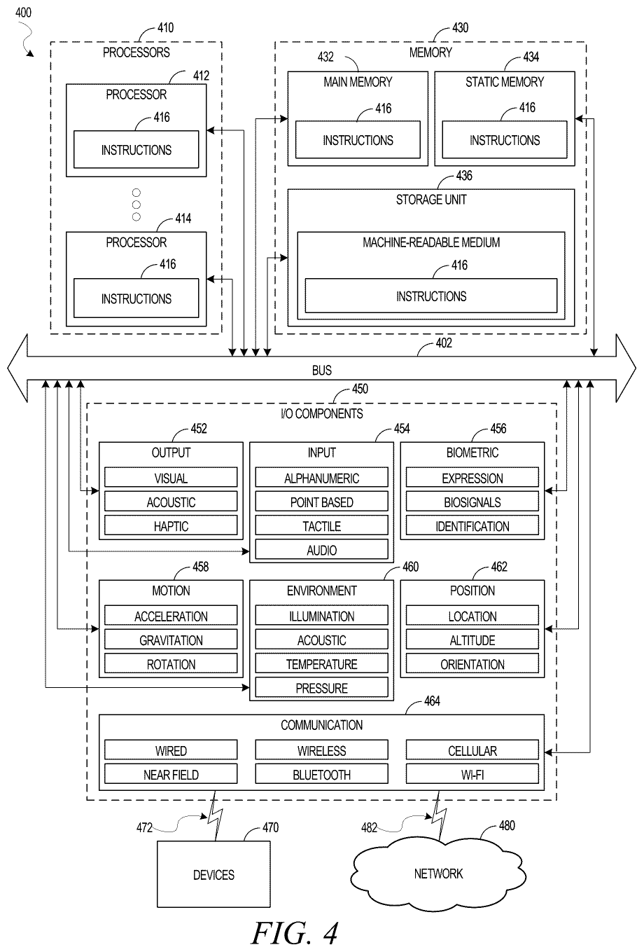

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that comprises processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various GUI functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method 200 of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
generating a first prompt comprising a request to modify a first portion of a document, the request comprising instructions to identify changes to the first portion of the document as one or more individual changes to the first portion and to output the changes in a first format;
sending the first prompt to a Large Language Model (LLM) for processing;
receiving, from the LLM, a single response comprising all of the one or more individual changes to the first portion, the single response not containing text of the first portion of the document not affected by the one or more individual changes; and
processing the single response using a software component designed to process instructions in the first format, the processing comprising modifying the first portion of the document based on the one or more individual changes.

2. The system of claim 1, wherein the first portion of the document comprises computer code.

3. The system of claim 1, wherein the single response comprises an array of one or more text replacement instructions.

4. The system of claim 3, wherein the array comprises, for each of the one or more text replacement instructions, a command to perform a replacement of one string for another string, written in a computer language executable by the software component.

5. The system of claim 3, wherein each of the one or more text replacement instructions identifies a unique starting string, a unique ending string, and replacement text.

6. The system of claim 3, wherein the one or more text replacement instructions indicate expansion of replacement text until the replacement text is unique.

7. The system of claim 3, wherein each of the one or more text replacement instructions identifies the single response comprising a JavaScript Object Notation (JSON) object.

8. The system of claim 1, wherein the operations further comprise:
rendering, in a graphical user interface, an indication of all of the one or more individual changes;
receiving input from a user, via the graphical user interface, indicating that a particular individual change of the one or more individual changes should not be implemented;
generating a second prompt comprising a second request to modify the first portion of the document, the second request comprising instructions to alter the particular individual change to a different individual change;
sending the second prompt to the LLM;
receiving, from the LLM, a second response comprising the different individual change; and
replacing the particular individual change with the different individual change in the one or more individual changes.

9. A method comprising:
generating a first prompt comprising a request to modify a first portion of a document, the request comprising instructions to identify changes to the first portion of the document as one or more individual changes to the first portion and to output the changes in a first format;
sending the first prompt to a Large Language Model (LLM) for processing;
receiving, from the LLM, a single response comprising all of the one or more individual changes to the first portion, the single response not containing text of the first portion of the document not affected by the one or more individual changes; and
processing the single response using a software component designed to process instructions in the first format, the processing comprising modifying the first portion of the document based on the one or more individual changes.

10. The method of claim 9, wherein the first portion of the document comprises computer code.

11. The method of claim 9, wherein the single response comprises an array of one or more text replacement instructions.

12. The method of claim 11, wherein the array comprises, for each of the one or more text replacement instructions, a command to perform a replacement of one string for another string, written in a computer language executable by the software component.

13. The method of claim 11, wherein each of the one or more text replacement instructions identifies a unique starting string, a unique ending string, and replacement text.

14. The method of claim 11, wherein each of the one or more text replacement instructions identifies the single response comprising a JavaScript Object Notation (JSON) object.

15. The method of claim 9, further comprising:
rendering, in a graphical user interface, an indication of all of the one or more individual changes;
receiving input from a user, via the graphical user interface, indicating that a particular individual change of the one or more individual changes should not be implemented;
generating a second prompt comprising a second request to modify the first portion of the document, the second request comprising instructions to alter the particular individual change to a different individual change;
sending the second prompt to the LLM;
receiving, from the LLM, a second response comprising the different individual change; and
replacing the particular individual change with the different individual change in the one or more individual changes.

16. A non-transitory machine-readable medium storing instructions which, when executed by one or more processors, cause the one or more processors to perform operations comprising:
generating a first prompt comprising a request to modify a first portion of a document, the request comprising instructions to identify changes to the first portion of the document as one or more individual changes to the first portion and to output the changes in a first format;
sending the first prompt to a Large Language Model (LLM) for processing;
receiving, from the LLM, a single response comprising all of the one or more individual changes to the first portion, the single response not containing text of the first portion of the document not affected by the one or more individual changes; and
processing the single response using a software component designed to process instructions in the first format, the processing comprising modifying the first portion of the document based on the one or more individual changes.

17. The non-transitory machine-readable medium of claim 16, wherein the first portion of the document comprises computer code.

18. The non-transitory machine-readable medium of claim 16, wherein the single response comprises an array of one or more text replacement instructions.

19. The non-transitory machine-readable medium of claim 18, wherein the array comprises, for each of the one or more text replacement instructions, a command to perform a replacement of one string for another string, written in a computer language executable by the software component.

20. The non-transitory machine-readable medium of claim 18, wherein each of the one or more text replacement instructions identifies a unique starting string, a unique ending string, and replacement text.
